(19) United States
(12) Patent Application Publication
(10) Pub. No.: US 2008/0263474 A1
(43) Pub. Date: Oct. 23, 2008

(54) MULTIPLE DISPLAY WINDOW HANDLING

(76) Inventor: CHRIS WORMALD, Kitchener (CA)

Correspondence Address: SMART AND BIGGAR, 438 UNIVERSITY AVENUE, SUITE 1500 BOX 111, TORONTO, ON, M5G2K8, CA

(21) Appl. No.: 11/737,250

(22) Filed: Apr. 19, 2007

(51) Int. Cl. G06F 3/048

(52) U.S. Cl. 715/803

(57) ABSTRACT

Display windows associated with one or more software applications are differentiated with a pictograph drawn in each window. The user can then quickly and easily distinguish between windows of the same application or between applications by referring to the pictograph, rather than having to read small text and graphics located in the title bar of the windows. A pictograph may be a watermark which is visible through any overlying text or graphics in the window.

### COPYRIGHT NOTICE

A portion of the disclosure of this patent document contains material which is subject to copyright protection. The copyright owner has no objection to the facsimile reproduction by any one of the patent document or patent disclosure, as it appears in a Patent Office patent file or records, but otherwise reserves all copyright rights whatsoever.

### BACKGROUND

This invention relates to displaying software applications running on a computing device.

An application running on a computing device may have multiple display windows. For example, a word processing application may have multiple display windows where each window displays a different file. Also, each software application running on a computing device typically executes in its own display window. Therefore it is not uncommon for a person to have multiple display windows opened simultaneously on a computing device.

In order to allow for multiple display windows to fit on a display (such as a computer monitor or a screen on a portable device) display windows are typically scalable from a fully maximized state (e.g. occupying the entirety of the display area) to a minimized state (e.g. occupying some small percentage of the total available display area). Moreover, display windows may be tiled one next to another or stacked one on top of another. When multiple display windows are open certain windows may be partially occluded by overlying display windows.

A display window is typically uniquely identified using alphanumeric text located on a title bar of the window. This title bar may appear at the top or bottom of the window. For example, in the case of a word processing application, the name of the file that the user is working on may appear in the title bar. The title bar may also contain a graphic, for example, if the application is a word processing program, the graphic may be an icon representative of the word processing program. Alternatively, in the case of a display window displaying files in a directory on a computer, the title bar may contain alphanumeric text showing the path of the directory.

Unfortunately, graphics and alphanumeric text located on the title bar tend to be very small and the text may be lengthy. This poses at least two problems for the user.

First, in order to distinguish between similar display windows of an application, such as two instances of a word processing program, a user may need to properly distinguish between multiple and lengthy texts on the title bars of the windows.

Second, as discussed above, when multiple display windows are open, overlying display windows may occlude underlying windows. Thus, the title bars of underlying windows may be completely or partially occluded. If the user cannot see the title bar or cannot see enough of the title bar to sufficiently identify a window he must move overlying windows out of the way.

A further problem is that graphics and alphanumeric text used to identify display windows may be unintuitive, thus challenging less sophisticated users. For instance, the title of a window displaying files on a memory device (for example, a digital camera) may be entitled “E:” while the title of a window displaying files on another device (for example, a personal digital assistant) may be “J:”. If a user wishes to drag files from one device to the other, the user must remember that an application title beginning with “E:” represents the digital camera while “J:” represents the personal digital assistant.

Based on the foregoing, it may be appreciated that there is a need for an improved method of differentiating between multiple display windows.

### DESCRIPTION OF THE DRAWINGS

FIG. 1 is a schematic view of a computing system in which example embodiments described herein may be used.

FIG. 2 is a screenshot of a display window configured in a known manner.

FIG. 3 is a screenshot of another display window configured in a known manner.

FIG. 4 is a screenshot of two display windows configured in a known manner.

FIG. 5 is a screenshot of an example application operating in accordance with the present disclosure.

FIG. 6 is a screenshot of an example display window configured in accordance with the present disclosure.

FIG. 6a is a screenshot of the display window of FIG. 6 sharing a display with another display window. The second window has a pictograph representative of the second application.

FIG. 7 is a screenshot of an example display window configured in accordance with the present disclosure with a pictograph associated with a device.

FIG. 7a is a screenshot of the device display window of FIG. 7 sharing a display with another device display window. The second device display window has a pictograph representative of the second device.

FIG. 8 is a flow diagram illustrating a method according to an aspect of the present disclosure.

FIG. 9 is a flow diagram illustrating a method according to another aspect of the present disclosure.

### DETAILED DESCRIPTION

Display windows associated with one or more software applications are differentiated with a pictograph drawn in each window. The user can then quickly and easily distinguish between windows of the same application or between applications by referring to the pictograph, rather than having to read small text and graphics located in the title bar of the windows. A pictograph may be a watermark which is visible through any overlying text or graphics in the window.

In one aspect, there is provided a method for facilitating handling of multiple software applications running on a computing device, comprising: presenting a first window on a display for said computing device, said first window displaying at least one of alphanumerics and graphics related to a first software application; presenting a second window on said display, said second window displaying at least one of alphanumerics and graphics related to a second software application; rendering a first pictograph representative of said first software application in said first window; rendering a second pictograph representative of said second software application in said second window, said second pictograph being visually different from said first pictograph; wherein said first pictograph is a watermark which is visible through any overlying alphanumerics and graphics in said first window.

In another aspect, there is provided a method for facilitating handling of multiple software applications running on a computing device, comprising: presenting a first window on a display for said computing device, said first window having a title bar and a body, said first window displaying at least one of alphanumerics and graphics related to a first software application; presenting a second window on said display, said second window having a title bar and a body, said second window displaying at least one of alphanumerics and graphics related to a second software application; obtaining a first pictograph representative of said first software application from said first software application; obtaining a second pictograph representative of said second software application from said second software application, said second pictograph being visually different from said first pictograph; rendering said first pictograph representative of said first software application in said body of said first window; rendering said second pictograph representative of said second software application in said body of said second window.

Related computing devices are also provided.

Other aspects and features will become apparent to those ordinarily skilled in the art upon review of the following description of example embodiments in conjunction with the accompanying figures.

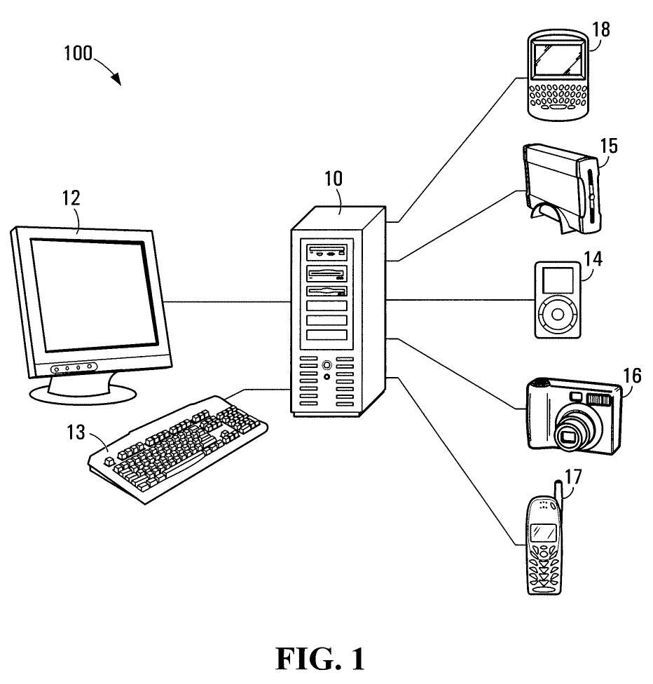

Referring to FIG. 1, a computing system 100 may comprise a computer 10 including a CPU and a memory (not shown), a display 12 such as a monitor and an input device 13 such as a keyboard. Computing system 100 may further include one of a number of portable devices connectable to the computer 10 using standard connections such as Universal Serial Bus (USB), IEEE 1394 (such as FireWire™) or Bluetooth™ connections. FIG. 1 shows several example devices that may be connected to computer 10: a personal digital assistant (PDA) 18, a music player 14, an external disk drive 15, a digital camera 16 and a handheld communication device 17.

Computer 10 may be a PC loaded with an operating system such as Microsoft Windows, Linux, Unix or Mac OS. The operating system loaded on computer 10 may natively support display windows. If not natively supported, add-on components providing display window capabilities may be installed on computer 10. Computer 10 may be configured to handle multiple applications each having a display window providing a separate user interface. Display windows running on computer 10 are displayed on display 12. Such applications, for example, a word processing application, may reside in memory on computer 10.

Portable devices are typically sold with accompanying software that may be loaded on computer 10. Through this software, users may interact with the portable device to perform functions such as transferring files between computer 10 and the portable device and synchronizing files on the portable device with corresponding files on computer 10 (or vice versa). Alternatively, if no software is provided, the portable device may be connected to the computer 10 and resident software may provide the user interface, as for example by recognizing the device as an additional memory drive.

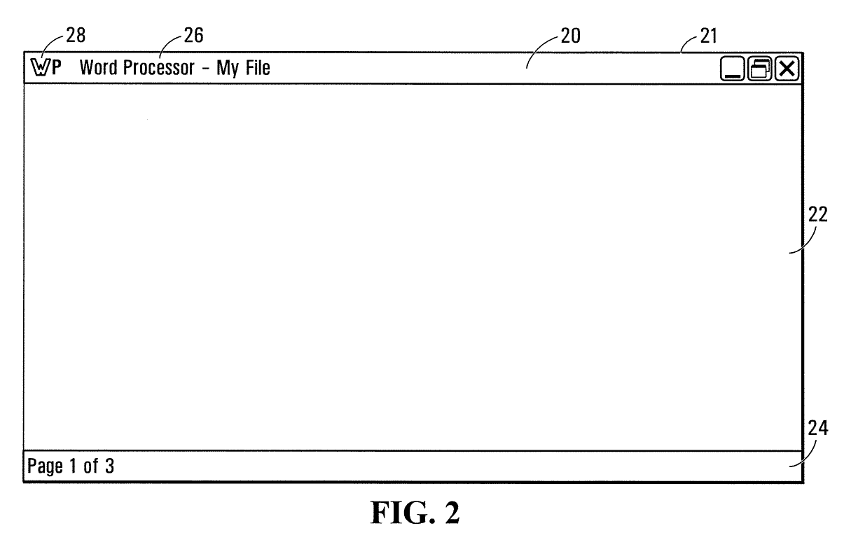

Typically, each application (whether a word processing application or a user interface application for a connected portable device) executes in one or more of its own display windows. FIG. 2 shows a typical display window 21 where the application is a word processor. Display window 21 has a tile bar 20, a body 22 and a footer bar 24. The tile bar 20 may contain an icon 28 representative of the word processing program and text 26 identifying the name of the file that is currently being displayed. Footer bar 24 may contain information such as the current page number. Alternatively, footer bar 24 may contain the file name.

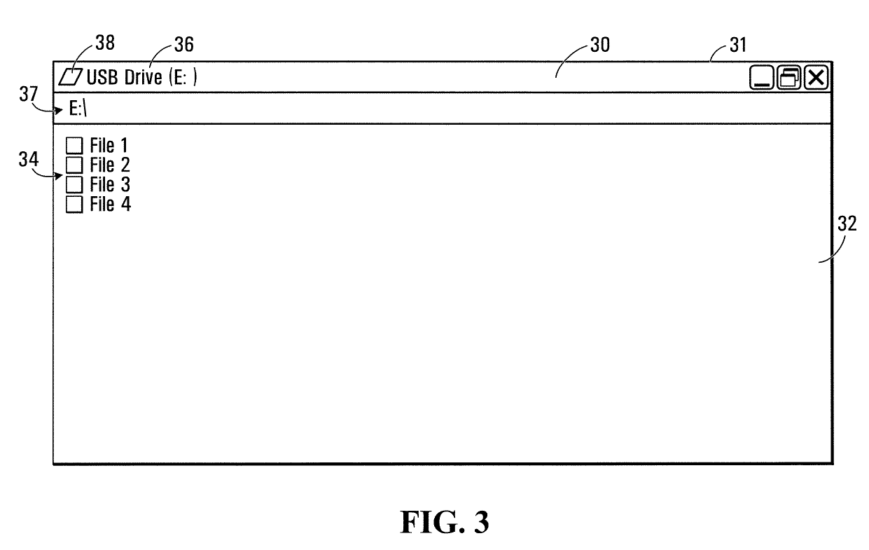

A portable device connectable to computer 10 may either be accessed through its dedicated software, if provided, or may be accessed by resident software on computer 10. In the first situation, the portable device software is typically similar to any of the other applications running on computer 10. In the latter case, where no software is provided, the portable device may appear as an additional memory drive. FIG. 3 illustrates the situation where the portable device is connected as an additional disk drive.

FIG. 3 shows a window 31 displaying the files located on a portable device—an external USB drive—where the device is connected as an additional disk drive on computer 10. As will be appreciated, the portable device may be any other portable device containing a memory such as a digital camera, a music player or a PDA. Returning to FIG. 3, the USB drive is connected as drive E: on computer 10, however, it may be connected and identified in other manners known to persons skilled in the art. Window 31 is similar to the display window 21 in FIG. 2. Window 31 has a title bar 30 containing an icon 38 representative of a disk drive, text 36 describing the name of the portable device and body 32 containing a listing of files 34. Files 34 reside on the USB drive. In addition, window 31 has an address bar 37 containing the path to files 34.

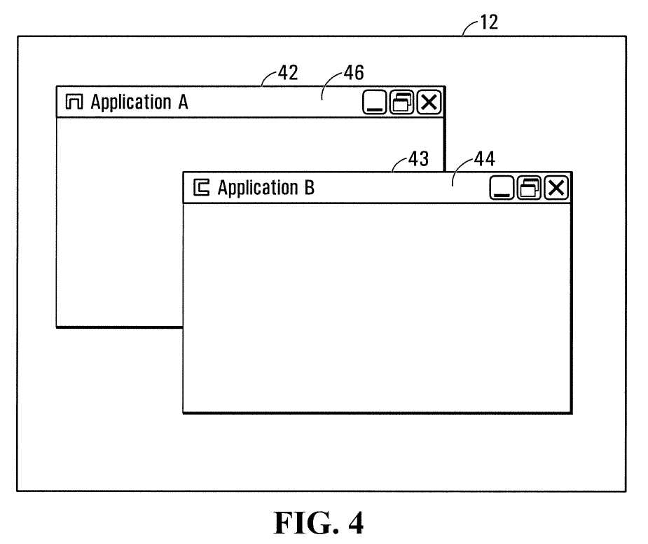

When a user is running multiple applications simultaneously, and/or using different aspects of any one application, multiple windows may be open on display 12. FIG. 4 shows two display windows, 42 and 44, on display 12. In particular, Application A executes in window 42 while Application B executes in window 44. Title bar 46 identifies window 42 as belonging to Application A while title bar 43 identifies window 44 as belonging to Application B. As illustrated in FIG. 4, part of window 42 is occluded by overlying window 44. Moreover, although not illustrated, it may be appreciated that should window 44 overlie the title bar 46 of window 42, this title bar would be occluded by window 44. In such a case, the user would not be able to see the text on title bar 46.

In overview, a method is provided whereby a user may easily identify and distinguish between display windows on a display. In addition to, or instead of, text and icons located in the title bar of a window, a pictograph representative of the window is rendered in the body of the window. The pictograph may be located in a corner of the window or may occupy a large percentage of the body area of the window. In this manner, even when a large area of an underlying window is occluded by an overlying window, at least some, if not all, of the pictograph may be visible to the user.

A pictograph may comprise alphanumeric characters or design graphics alone, or may be a combination of the two. Furthermore, the pictograph may be solid and therefore block out any underlying graphics or text in a window, or translucent (i.e., a watermark) therefore allowing underlying graphics or text in the window to be seen through the pictograph.

A pictograph may be representative of a relevant aspect of an application (where the application may run multiple windows), the application itself, or a portable device associated with the application. Indeed, each application or portable device may contain a graphics file with a pictograph representative of itself and where an application can run multiple different windows, the application may contain a graphics file for each aspect of the application which runs in a separate window. Alternatively, an application or portable device may contain a file or files with instructions, which when interpreted by computer 10, causes computer 10 to render a pictograph representative of the application (or an aspect of the application) or portable device in a window. Upon connection of the portable device to computer 10, or upon launching the application, computer 10 may query the application or portable device for the pictograph(s) or instruction file(s). Alternatively, upon connection with computer 10, the application or portable device may push the pictograph(s) or instruction file(s) to computer 10. Once in receipt of the pictograph or instruction file, computer 10 may render the pictograph in the window associated with the relevant aspect of the application (in the single application embodiment), the application (in the multiple application embodiment) or portable device.

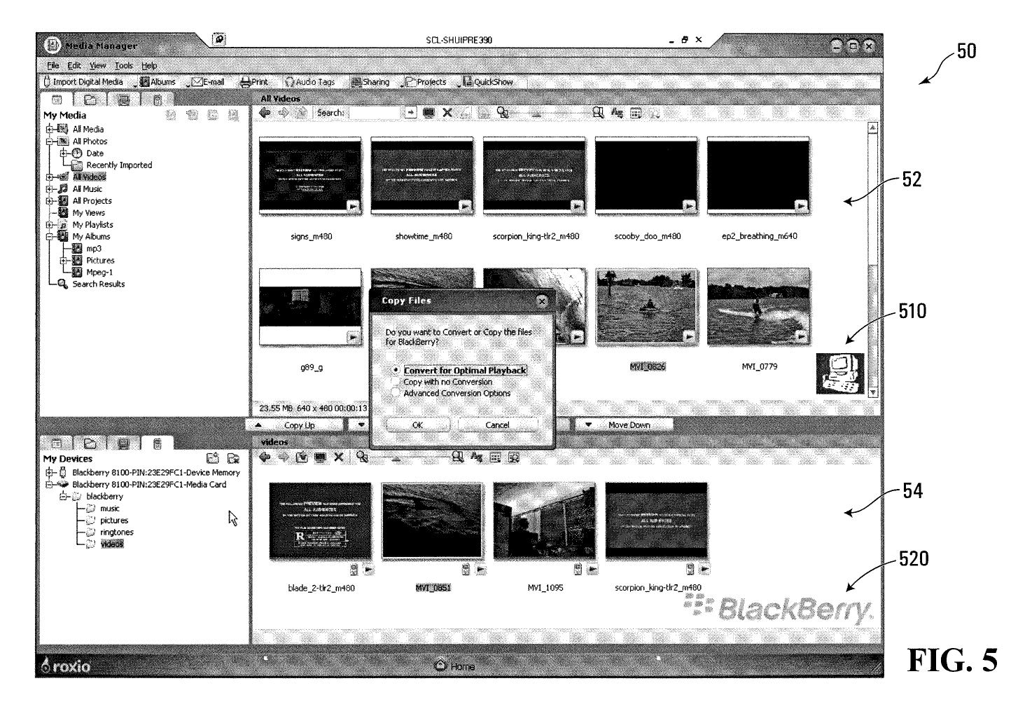

The foregoing is described in more detail below in conjunction with FIGS. 5 to 8.

FIG. 5 illustrates an example embodiment where pictographs, such as a watermark, are used to distinguish between different display windows of a single application. Specifically, the embodiment illustrated is in the context of a Media Manager application. The Media Manager application allows a user to drag and drop video files

between a PC and a handheld communications device such as a BlackBerry™ device manufactured by Research in Motion Limited.

Specifically, the Media Manager program runs in a primary display window 50. However, the Media Manager program also runs in two subwindows, 52 and 54. Subwindow 52 shows files located in memory on the PC, as identified by pictograph 510 illustrating a PC, and subwindow 54 shows files located in memory on the BlackBerry™ device, as identified by pictograph 520 illustrating a BlackBerry™ logo. Pictographs 510 and 520 may, of course, comprise other graphics and/or alphanumeric text. Each pictograph uniquely identifies a relevant aspect of each subwindow—in this case, whether the window relates to the PC or the BlackBerry™. It is optional, but not required, that the content of the pictograph 510 or 520 be conceptually related to the relevant aspect of the application so as to aid association by users between the pictograph 510 or 520 and the relevant aspect of the application.

It will be appreciated that the example embodiment illustrated in FIG. 5 is not limited to a Media Manager program but may be used to distinguish between multiple windows of any application. For example, each window within an application could represent a different portable device or folder in memory. A pictograph representative of a portable device or folder may be rendered in the associated display window. The pictograph may also be the name of the portable device or folder or may be the path to the folder.

In general, a user may launch an application which comprises two or more display windows. Each display window may be associated with an aspect of the application. For example, each display window within an application may display files in different memory locations. The memory location may be a disk drive of a computing device (including subfolders on or partitions of the disk drive) or may be an external disk drive connectable to the computing device. An external disk drive may also be a component of a portable device such as a digital camera, PDA or music player. It will be appreciated, however, that display windows within an application could be associated with other aspects of the application.

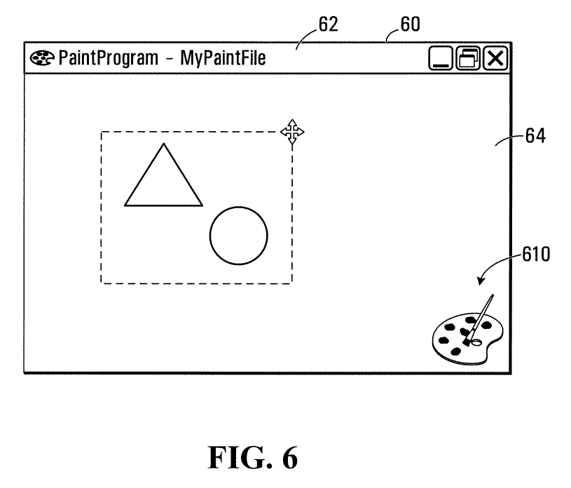

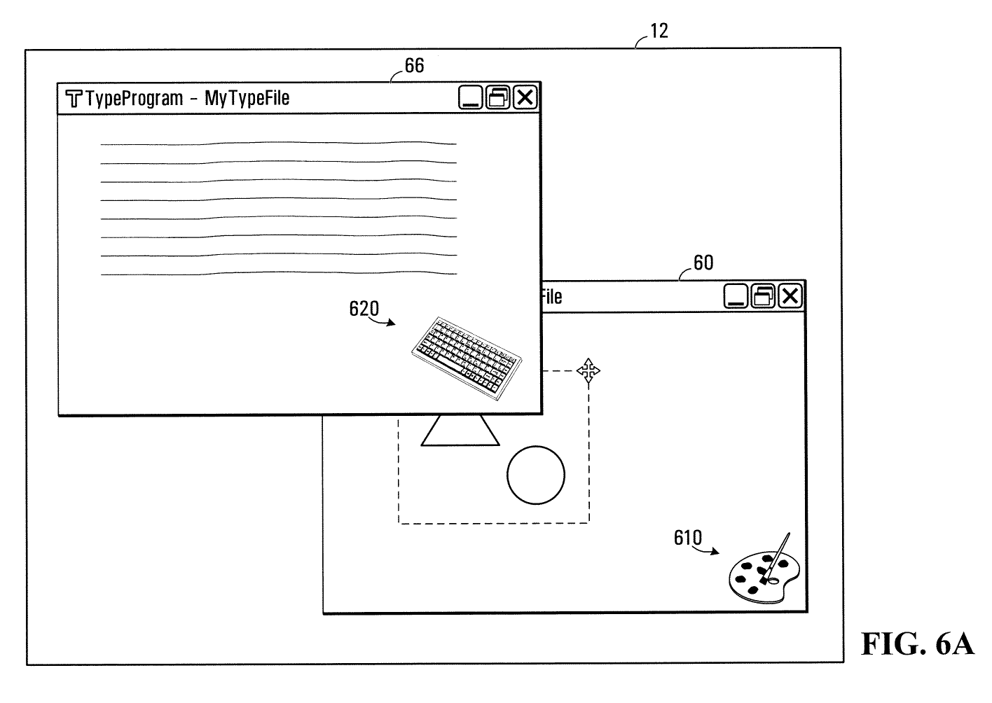

Reference is now made to FIG. 6 which shows a screenshot of an example display window 60. Like a conventional display window, display window 60 has a title bar 62 and a body 64. Title bar 62 identifies window 60 as belonging to the PaintProgram application (a fictitious graphics application). However, unlike a conventional display window, a pictograph 610 associated with the PaintProgram application appears in the lower right corner of the body 64 of window 60. Pictograph 610 comprises a paint palette and a paintbrush. Pictograph 610 may, of course, comprise other graphics and or alphanumeric text. It is optional, but not required, that a pictograph be conceptually related to its associated memory location so as to aid association by users between the pictograph and its associated application

FIG. 6a is a screenshot of display window 60 of FIG. 6 sharing a display 12 with another display window 66. Display window 66 is associated with the TypeProgram application (a fictitious word processing application). Pictograph 620, a graphic of a keyboard, is associated with the TypeProgram application and is rendered in the body of window 66. As illustrated, window 66 occludes the title bar of window 60 and thus prevents a user from viewing the text identifying window 60. Conventionally, if a user is unsure of which display window 60 belongs to, he or she would have to move window 66 out of the way in order to view the title bar of window 60. However, in accordance with the present embodiment, the user is able to quickly identify window 66 as belonging to the PaintProgram application despite the occlusion of its title bar because pictograph 610 remains visible.

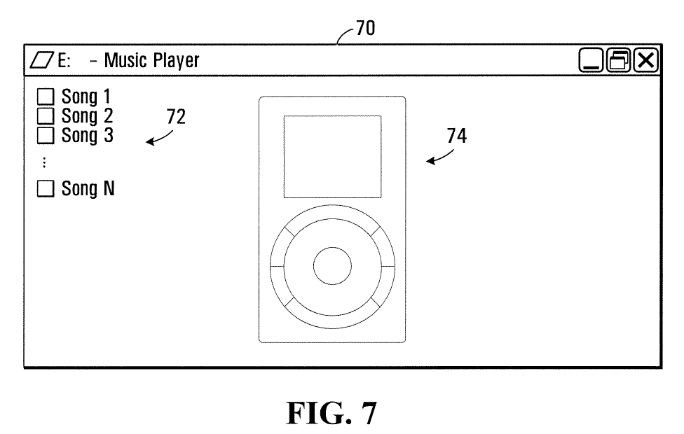

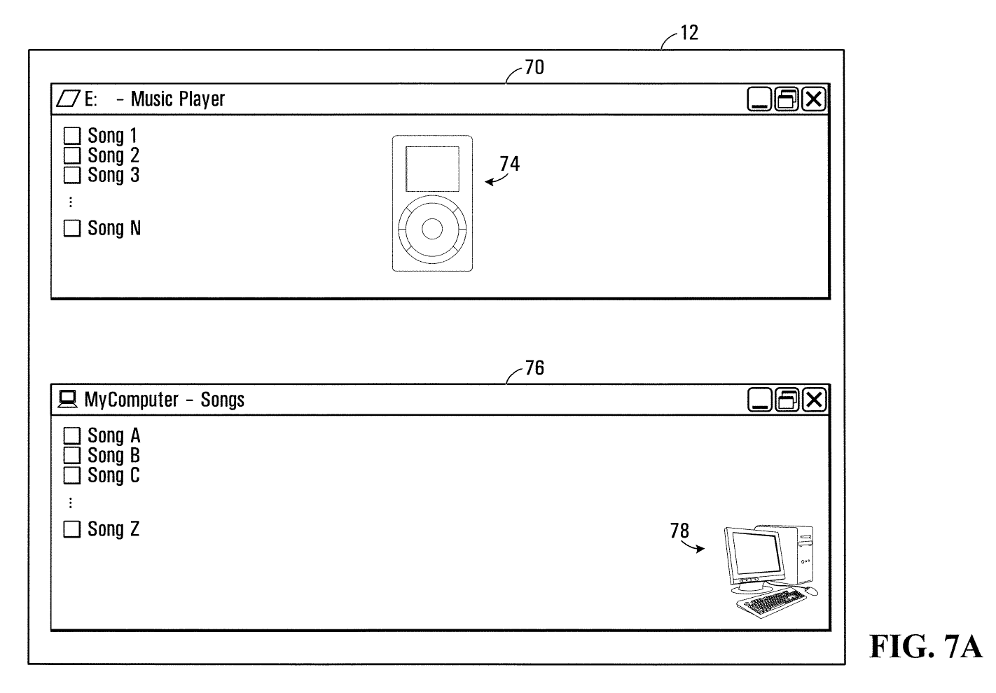

FIG. 7 shows a window 70 associated with a device, in this example, a music player. Window 70 displays a list of files 72 stored on the music player. Pictograph 74 identifies window 70 as associated with the music player. Pictograph 74 is located in the middle of the body of window 70 and occupies a large percentage of the display area of window 70. Pictograph 74 may be solid or may be translucent (i.e., a watermark).

FIG. 7a illustrates window 70 and another window 76 sharing the display 12. Window 76 is associated with a PC (as identified by the pictograph 78 of a PC). Window 76 contains a listing of files stored on the PC. As illustrated, in the absence of pictographs 74 and 78, windows 70 and 76 appear very similar. Therefore, a user who wishes to, for example, drag files from one window to another (to transfer files from the PC to the music player or vice versa), would have to read the text located in the title bar of each window in order to identify the window belonging to the music player (or PC). However, the addition of pictographs 74 and 78 facilitate such identification.

In general, a user may launch two applications, Application A and Application B. On launch, Application A may open in its own window and a pictograph representative of Application A may be rendered in the window. Similarly, Application B may open in its own window and a pictograph representative of Application B may be rendered in the window associated with Application B.

It may be advantageous to have a pictographic representation cover at least 5% of the display area of a body of a window so that there is a good likelihood it will be visible in various multi-window configurations. Indeed, especially where the pictograph is a watermark, it may be advantageous for the pictograph to cover at least 50% of the display area of the body of the window, again to provide a good likelihood the pictograph will be visible in various multi-window configurations. In addition, when the window is resized by the user, the pictograph may be automatically resized accordingly. For example, if the pictograph covers 50% of the display area of the body of the window, and a user resizes the window, the pictograph may resize automatically so that it covers 50% of the display area of the resized window.

Although not preferred, it may be possible to have the pictograph overlap with the title bar of a window, particularly where the pictograph is a watermark.

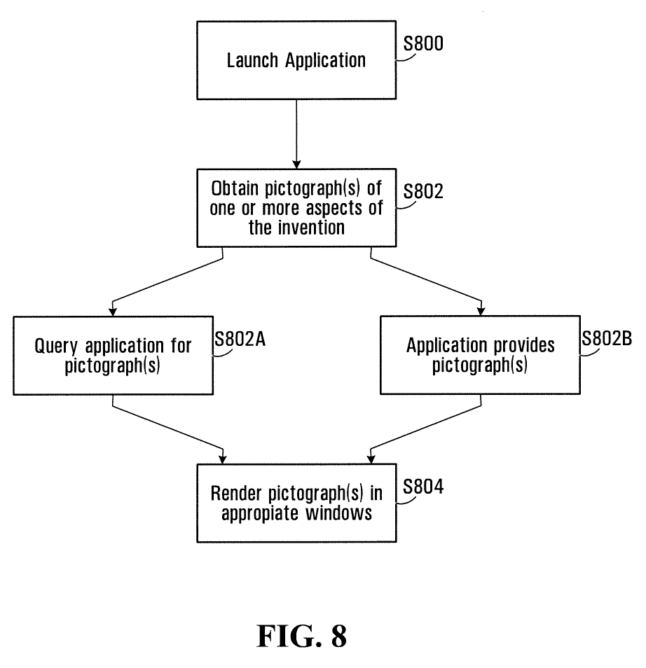

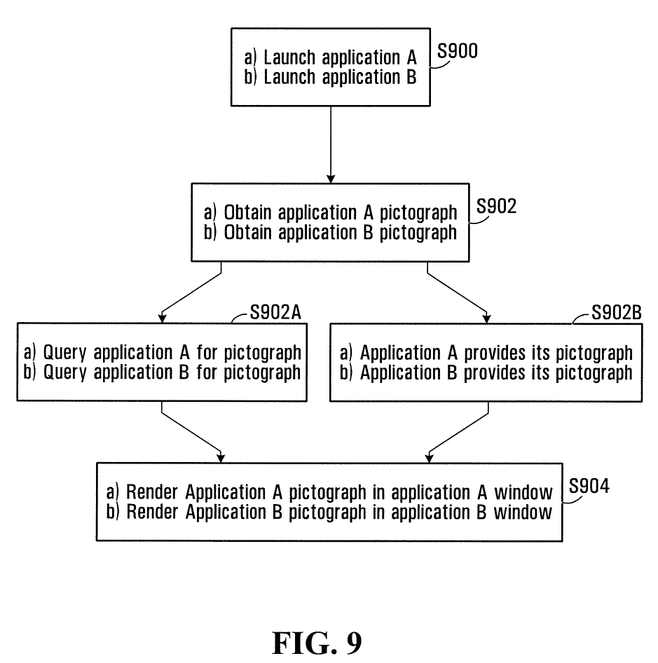

Suitable methods for achieving the foregoing are illustrated in FIGS. 8 and 9.

More specifically, in a single application embodiment, upon launching an application (FIG. 8, S800), computer 10 may obtain pictograph files associated with one or more aspects of the application (FIG. 8, S802) and render each pictograph in the appropriate window. Computer 10 may obtain the pictographs by querying the application (FIG. 8, S802a). Alternatively, the application may provide (for example by pushing) the pictograph (FIG. 8, S802b) to computer 10 for rendering (FIG. 8, S804). In the latter case, instead of querying the application, computer 10 may receive the pictograph file from the application upon launch. Optionally, computer 10 may store the pictograph(s) associated with a relevant aspect(s) of the application the first time it receives the pictograph. Thereafter, computer 10 need not query the application and the application need not provide relevant pictographs to computer 10 each time the application is launched.

In a multiple application embodiment, Applications A and B may each contain a file defining its pictograph in for example .gif or .jpg formats. Upon launch (FIG. 9, S900), computer 10 may obtain the pictograph files from Applications A and B (FIG. 9, 902) and render each pictograph in the appropriate window. Computer 10 may obtain the pictographs by either querying the applications (FIG. 9, S902a), or alternatively, the applications may provide (for example by pushing) the pictographs (FIG. 9, S902b) to computer 10 for rendering upon launch (FIG. 9, S904). In the latter case, instead of querying the application, computer 10 may receive pictograph files from the applications upon launch. Optionally, computer 10 may store the pictograph associated with an application the first time it receives the application's pictograph. Thereafter, computer 10 need not query the application and the application need not provide its pictograph to computer 10 each time the application is launched.

In a further embodiment, an application may comprise instructions, which when interpreted by computer 10, cause computer 10 to render a pictograph associated with aspects of the application or the application itself. More specifically, instead of the pictograph being encapsulated in for example a .gif or .jpg file, instructions for rendering the pictograph could be contained in a computer executable file. This type of implementation may be useful where, for example, a platform-specific pictograph is desired (e.g. the pictograph file could contain computer executable instructions to render the pictograph in different manners depending upon the target display).

The software application may be a device driver for driving a particular portable device. Alternatively, the software application associated with a device could be a standalone program, such as a Media Manager, for managing media files on different types of portable devices (e.g. FIG. 5) or it could be a software application already resident on computer 10 (e.g. as included with the operating system running on computer 10). The pictograph associated with a portable device could be, for example, a representation of the portable device.

Although reference has been made to software applications running on a PC, it may be appreciated that the software applications could run on other computing devices with a suitable display and therefore the teachings herein may be applied to other types of computing devices.

Other modifications will be apparent to those skilled in the art.

What is claimed is:

1. A method for facilitating handling of multiple display windows running on a computing device, comprising:
presenting a first window on a display for said computing device, said first window displaying at least one of alphanumerics and graphics;
presenting a second window on said display, said second window displaying at least one of alphanumerics and graphics;
rendering a first pictograph representative of said first window in said first window;
rendering a second pictograph representative of said second window in said second window, said second pictograph being visually different from said first pictograph;
wherein said first pictograph is a watermark which is visible through any overlying alphanumerics and graphics in said first window.

2. The method of claim 1 wherein said presenting a first window on a display comprises launching a first software application which runs said first window and wherein presenting a second window on said display comprises launching a second software application which runs said second window.

3. The method of claim 1 wherein said rendering a first pictograph comprises rendering said watermark so as to cover at least 5% of said first window.

4. The method of claim 1 wherein said rendering a first pictograph comprises rendering said watermark so as to cover at least 50% of said first window.

5. The method of claim 1 comprising storing said first pictograph in association with an indication of said first window and, on launching said first window, retrieving said first pictograph for said rendering said first pictograph.

6. The method of claim 2 wherein said first software application is a device driver and said presenting said first window comprises presenting said first window displaying at least one of alphanumerics and graphics associated with a device driven by said device driver.

7. A method for facilitating handling of multiple display windows running on a computing device, comprising:
presenting a first window on a display for said computing device, said first window having a title bar and a body, said first window displaying at least one of alphanumerics and graphics;
presenting a second window on said display, said second window having a title bar and a body, said second window displaying at least one of alphanumerics and graphics;
obtaining a first pictograph representative of said first window;
obtaining a second pictograph representative of said second window, said second pictograph being visually different from said first pictograph;
rendering said first pictograph representative of said first window in said body of said first window;
rendering said second pictograph representative of said second window in said body of said second window.

8. The method of claim 7 wherein said presenting a first window on a display comprises launching a first software application which runs said first window and wherein presenting a second window on said display comprises launching a second software application which runs said second window.

9. The method of claim 8 wherein said rendering said first pictograph representative of said first window on said first window comprises rendering a watermark in said first window.

10. The method of claim 7 wherein said rendering said first pictograph representative of said first window in said first window comprises rendering said pictograph so as to occupy at least 5% of said first window.

11. The method of claim 7 wherein said rendering said first pictograph representative of said first window on said first window comprises rendering a watermark in said first window so as to occupy at least 50% of said first window.

12. The method of claim 7 wherein said obtaining a first pictograph representative of said first window comprises querying a software application running in said first window for a pictographic watermark.

13. The method of claim 7 wherein said obtaining a first pictograph representative of said first window comprises receiving said first pictograph from a software application running in said first window.

14. The method of claim 7 further comprising constructing said first pictograph based on information received from a software application running in said first window.

15. The method of claim 8 wherein said first software application is a device driver.

16. The method of claim 15 wherein said device driver drives a memory device and further comprising displaying on said first window at least one alphanumeric or graphic representative of a file on said memory device.

17. A computing device facilitating handling of multiple display windows, comprising:
a display;
a processor operable to:
present a first window on a display for said computing device, said first window displaying at least one of alphanumerics and graphics;
present a second window on said display, said second window displaying at least one of alphanumerics and graphics;
render a first pictograph representative of said first window in said first window;
render a second pictograph representative of said second window in said second window, said second pictograph being visually different from said first pictograph;
wherein said first pictograph is a watermark which is visible through any overlying alphanumerics and graphics in said first window.

18. A computing device facilitating handling of multiple display windows, comprising:
a display;
a processor operable to:
present a first window on a display for said computing device, said first window having a title bar and a body, said first window displaying at least one of alphanumerics and graphics;
present a second window on said display, said second window having a title bar and a body, said second window displaying at least one of alphanumerics and graphics;
obtain a first pictograph representative of said first window;
obtain a second pictograph representative of said second window, said second pictograph being visually different from said first pictograph;
render said first pictograph representative of said first window in said body of said first window;
render said second pictograph representative of said second window in said body of said second window.
